(19) United States
(12) Patent Application Publication
(10) Pub. No.: US 2008/0207862 A1
(43) Pub. Date: Aug. 28, 2008

(54) THIN FILM FORMED FROM POLYCYCLIC ALICYCLIC COMPOUND AS PRECUSER AND PRODUCTION METHOD THEREOF

(75) Inventors: Hirotoshi Ishii, Sodegaura-shi (JP); Tatsuru Shirafuji, Kyoto-shi (JP); Shizuo Fujita, Kyoto-shi (JP); Kunihide Tachibana, Kyoto-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 12/035,064

(22) Filed: Feb. 21, 2008

(30) Foreign Application Priority Data
Feb. 22, 2007 (JP) 2007-042096

(51) Int. Cl. C08F 232/00; C08J 7/18

(52) U.S. Cl. 526/308; 427/488

(57) ABSTRACT

A thin film formed from at least one polycyclic alicyclic compound selected from among compounds of the following formulas (1), (2) and (3) as a precursor.

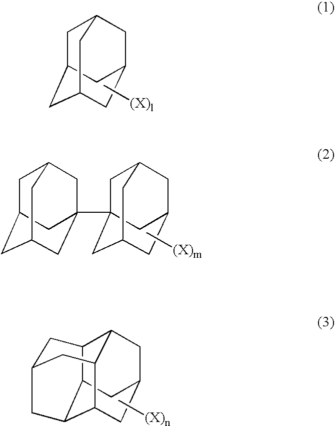

### TECHNICAL FIELD

The invention relates to a thin film useful as a semiconductor insulating interlayer, an optical film, and the like utilized in the electrical and electronic fields, semiconductor integrated circuits, and optics.

### BACKGROUND

A low-dielectric material is widely used as a material which forms an insulating interlayer of semiconductor integrated circuits in order to eliminate problems such as electrification or an increase in resistance. A low-dielectric material is used to improve economic efficiency and reduce a dielectric constant. Since a low-dielectric material is often used for a portion which produces heat or used as a thin film, a low-dielectric material is required to exhibit high heat resistance, high strength, and the like.

Application of thin films using various materials as an insulating interlayer has been studied. In particular, a thin film produced by plasma polymerization using an organic compound as a precursor has attracted attention since a low dielectric constant, high heat resistance, high strength, or high economic efficiency can be achieved.

A siloxane compound is mainly used as a semiconductor insulating interlayer material for which a low-dielectric material is mainly used. A siloxane compound contains silicon and oxygen as the main components. Since the dielectric constant increases as the molecular dipole moment increases, a siloxane compound having a number of lone electron pairs is disadvantageous from the viewpoint of a decrease in dielectric constant. Since a dielectric constant k of about four has been required for a low-dielectric material, a siloxane compound has been used as a low-dielectric material from the viewpoint of the balance between strength and adhesion to a silicon wafer.

However, since a reduction in the line width of semiconductor circuits has been desired along with a demand for an increase in performance, a further decrease in dielectric constant has been required.

On the other hand, it is necessary to maintain the strength of a thin film in view of the strength of the entire semiconductor integrated circuit and dielectric breakdown due to physical stress or the like. From the viewpoint of a decrease in dielectric constant, an organosiloxane compound has been used instead of an inorganic siloxane compound, and technology which introduces nanometer-level controlled holes in a thin film has been developed.

It is necessary to increase the number of pores introduced into in a thin film in order to further decrease the dielectric constant. However, the strength of the thin film decreases as the number of pores increases. Therefore, novel materials such as organic polymers have been proposed. However, a material which has insulating properties, a low dielectric constant, high strength, and particularly heat resistance sufficient to withstand a thermal load applied during semiconductor production has not yet been proposed.

In view of such a situation, Patent Document 1 discloses an organic/inorganic polymer such as a borazine-silicon polymer, for example. The polymer disclosed in Patent Document 1 has a low dielectric constant, high strength, and high heat resistance. However, since a platinum catalyst necessary for polymerization is not removed from the polymer disclosed in Patent Document 1, dielectric breakdown occurs or stability decreases due to the remaining platinum atoms.

In order to deal with this drawback, Patent Document 2 proposes a borazine polymer produced by plasma polymerization and a method of forming a borazine-containing silicon polymer film. The borazine polymer disclosed in Patent Document 2 has a low dielectric constant, but has low strength. The borazine-containing silicon polymer disclosed in Patent Document 2 has high strength, but does not have a sufficiently low dielectric constant. Specifically, an insulating interlayer having a low dielectric constant and high strength cannot be obtained according to the technology disclosed in Patent Document 2.

Patent Document 3 proposes a method of forming a polyadamantane ether film by plasma polymerization using an adamantane polyol. Patent Document 4 proposes a diamantane derivative polymer having an alkenyl group, an alkynyl group, a hydroxyl group, or an ether group, and a method of forming an adamantane derivative polymer film by plasma polymerization. It is difficult to obtain a thin film using an adamantane derivative or its analog. On the other hand, a thin film having a low dielectric constant, high strength, and high heat resistance may be obtained using an adamantane derivative or its analog.

According to the method disclosed in Patent Document 3, the resulting thin film has a high oxygen atom content with respect to the total number of carbon atoms. According to the method disclosed in Patent Document 4, since the precursor has an alkenyl group, an alkynyl group, a hydroxyl group, or an ether group, the resulting thin film contains a considerable amount of ether structure or the like derived from such a group. Therefore, a decrease in dielectric constant, an increase in strength, and an increase in heat resistance of the thin films obtained by these methods are limited.

Note that it is impossible to form a thin film of a polycyclic alicyclic compound having a similar structure by chemical synthesis because the polymer which forms the thin film is insoluble and infusible.

### [Patent Document 1] JP-A-2002-359240

### [Patent Document 2] JP-A-2006-032745

### [Patent Document 3] JP-A-2003-252982

### [Patent Document 4] JP-A-2006-100794

A main technical object of the invention is to provide a thin film which has a low dielectric constant, high strength, and high heat resistance, and a method of producing the same.

### SUMMARY OF THE INVENTION

The inventors of the invention found that a thin film formed using a polycyclic alicyclic compound (i.e., adamantane, biadamantane, diamantane, or a specific derivative thereof) as a precursor exhibits excellent performance. This finding has led to the completion of the invention.

According to the invention, the following thin film and the like are provided.

1. A thin film formed from at least one polycyclic alicyclic compound selected from among compounds of the following formulas (1), (2), and (3) as a precursor:

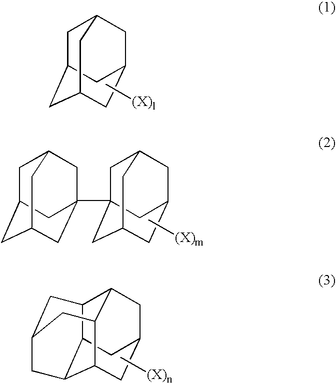

wherein X is a halogen group, a carboxyl group, a silyl group, a siloxy group, a nitro group, an amino group, an epoxy group, a fluorine-containing aliphatic group, a fluorine-containing aromatic group, a methyl group, an ethyl group, a substituted or unsubstituted saturated linear aliphatic group having 3 to 20 carbon atoms, a substituted or unsubstituted saturated branched aliphatic group having 3 to 20 carbon atoms, a substituted or unsubstituted saturated alicyclic substituent having 3 to 50 carbon atoms, or a substituted or unsubstituted aromatic group having 6 to 30 carbon atoms; l, m, and n represent the number of the substituents X, provided that 1 is an integer from 0 to 10, m is an integer from 0 to 18, and n is an integer from 0 to 14;

when l, m, or n is two or more, the substituents X may be the same or different, and may be bonded to a single carbon atom or different carbon atoms.

2. The thin film according to 1, wherein the polycyclic alicyclic compound is at least one polycyclic alicyclic compound selected from among adamantane, biadamantane, diamantane, and compounds of the following formulas (4) to (15):

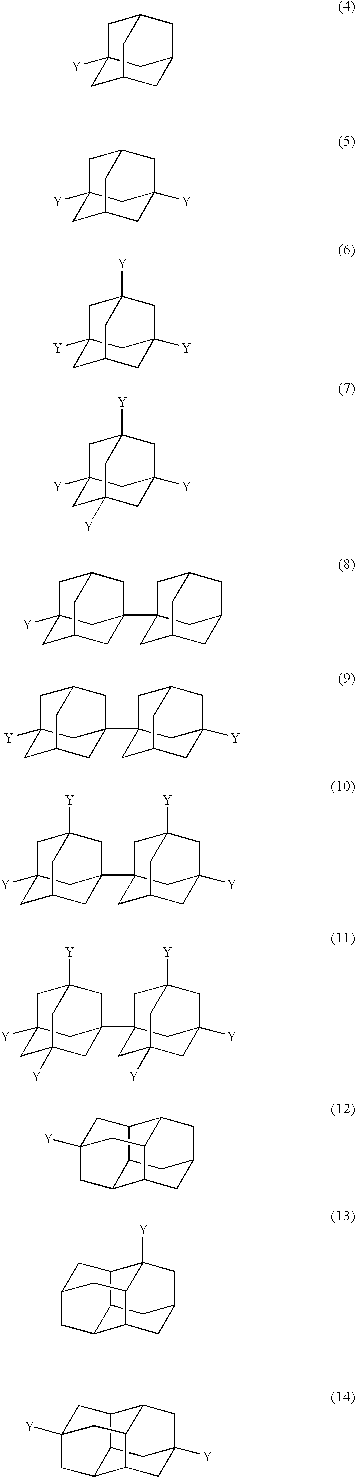

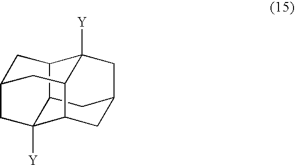

wherein Y is a bromo group or a carboxyl group, and, when there are two or more groups Y, the groups Y may be the same or different.
3. A method of producing the thin film according to 1 or 2, which is formed by plasma polymerization from the polycyclic alicyclic compound.
4. A low-dielectric material comprising the thin film according to 1 or 2.
5. An insulating interlayer for a semiconductor comprising the thin film according to 1 or 2.
6. An optical film comprising the thin film according to 1 or 2.
7. A high-strength, high-heat-resistant material comprising the thin film according to 1 or 2.
8. A semiconductor device comprising the thin film according to 1 or 2.
9. An image display comprising the thin film according to 1 or 2.
10. An electronic circuit device comprising the thin film according to 1 or 2.
11. A surface protective film comprising the thin film according to 1 or 2.

According to the invention, a thin film having a low dielectric constant, high strength, and high heat resistance, and a method of producing the same can be provided.

### BRIEF DESCRIPTION OF THE DRAWINGS

FIG. 1 is a schematic view showing an inductively-coupled plasma polymerization device.

### DETAILED DESCRIPTION OF THE PREFERRED EMBODIMENTS

A thin film according to the invention is formed from at least one polycyclic alicyclic compound selected from among compounds of the following formulas (1), (2), and (3) as a precursor.

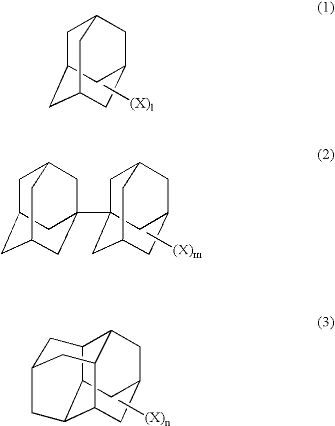

wherein X is a halogen group, a carboxyl group, a silyl group, a siloxy group, a nitro group, an amino group, an epoxy group, a fluorine-containing aliphatic group, a fluorine-containing aromatic group, a methyl group, an ethyl group, a substituted or unsubstituted saturated linear aliphatic group having 3 to 20 carbon atoms, a substituted or unsubstituted saturated branched aliphatic group having 3 to 20 carbon atoms, a substituted or unsubstituted saturated alicyclic substituent having 3 to 50 carbon atoms, or a substituted or unsubstituted aromatic group having 6 to 30 carbon atoms.

When X has a substituent, X is a group formed by combining the above-mentioned groups.

Examples of the fluorine-containing aliphatic group represented by X include fluorine-containing saturated linear aliphatic groups having 1 to 10 carbon atoms, fluorine-containing saturated branched aliphatic groups having 3 to 10 carbon atoms, and fluorine-containing saturated alicyclic substituents having 3 to 10 carbon atoms.

Of these, a trifluoromethyl group, a pentafluoroethyl group, a perfluorocyclohexyl group, and a perfluorocyclopentyl group are preferable. The heat resistance and the stability of a thin film obtained using these fluorine-containing aliphatic groups are particularly improved as compared with the case of using other fluorine-containing aliphatic groups.

Examples of the fluorine-containing aromatic group represented by X include fluorine-containing aromatic groups having 6 to 14 carbon atoms.

Of these, a pentafluorophenyl group and a heptafluoronaphthyl group are preferable. The performance of a thin film obtained using these fluorine-containing aromatic groups is equal to that of thin films obtained using other fluorine-containing aromatic groups. However, polycyclic alicyclic compounds having these groups are easily produced.

Examples of the substituted or unsubstituted saturated linear aliphatic group having 3 to 20 carbon atoms represented by X include an n-propyl group, an n-butyl group, an n-heptyl group, an n-hexyl group, an n-octyl group, an n-decyl group, an n-dodecyl group, and the like.

Of these, an n-propyl group, an n-butyl group, and an n-hexyl group are preferable. The heat resistance and the stability of a thin film obtained using these saturated linear aliphatic groups are particularly improved as compared with thin films obtained using other saturated linear aliphatic groups.

Examples of the substituted or unsubstituted saturated branched aliphatic group having 3 to 20 carbon atoms represented by X include an iso-propyl group, an iso-butyl group, a 1-methylpentyl group, a 1-ethylbutyl group, and the like.

Of these, an iso-propyl group and an iso-butyl group are preferable. The heat resistance and the stability of a thin film obtained using these saturated branched aliphatic groups are particularly improved as compared with thin films obtained using other saturated branched aliphatic groups.

Examples of the substituted or unsubstituted saturated alicyclic substituent having 3 to 50 carbon atoms represented by X include a cyclopropyl group, a cyclobutyl group, a cyclopentyl group, a cyclohexyl group, a cyclooctyl group, a cyclododecyl group, and the like.

Of these, a cyclopropyl group, a cyclobutyl group, a cyclopentyl group, and a cyclohexyl group are preferable. The heat resistance and the stability of a thin film obtained using these saturated alicyclic substituents are particularly improved as compared with thin films obtained using other saturated alicyclic substituents.

Examples of the substituted or unsubstituted aromatic group having 6 to 30 carbon atoms represented by X include a phenyl group, a toluoyl group, a dimethylphenyl group, a trimethylphenyl group, a tetramethylphenyl group, a pentamethylphenyl group, a naphthyl group, an anthracenyl group, and the like.

Of these, a phenyl group and a naphthyl group are preferable. When applying a thin film obtained using these aromatic groups as a semiconductor insulating interlayer, the thin film exhibits particularly improved insulating properties as compared with thin films obtained using other aromatic groups.

l, m, and n represent the number of substituents X. l is an integer from 0 to 10, m is an integer from 0 to 18, and n is an integer from 0 to 14. When l, m, or n is two or more, the substituents X may be the same or different, and may be bonded to a single carbon atom or to different carbon atoms.

According to the invention, a thin film can be easily obtained by plasma polymerization while achieving a decrease in dielectric constant, an increase in heat resistance, and an increase in strength of the thin film using a compound selected from the compounds of the formulas (1) to (3) as a precursor.

According to related-art methods, when forming a thin film by plasma polymerization, a precursor contains a large number of substituents (e.g., alkenyl group, hydroxyl group, or ether group) which take part in a reaction. Since the resulting thin film contains these substituents or a structure derived from these substituents, the dielectric constant, strength, and heat resistance of the thin film are adversely affected. According to the invention, a polycyclic alicyclic compound which does not contain an alkenyl group, a hydroxyl group, or an ether group, or a polycyclic alicyclic compound which has a substituent that produces an active site upon elimination is used as the precursor. Therefore, the effect of the substituent of the precursor on the performance of the resulting thin film can be eliminated.

The polycyclic alicyclic compound is preferably at least one polycyclic alicyclic compound selected from among adamantane, biadamantane, diamantane, and compounds of the following formulas (4) to (15).

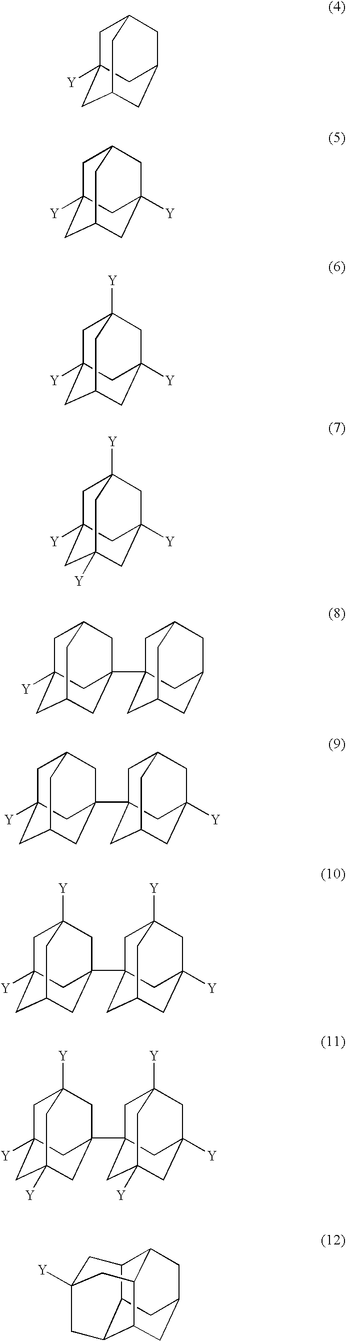

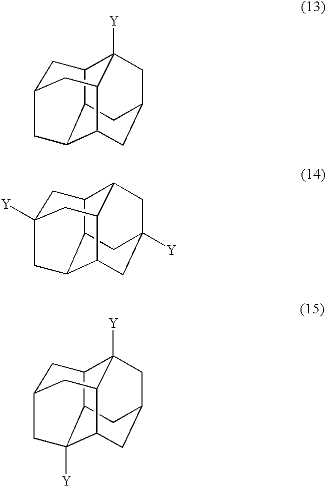

wherein Y is a bromo group or a carboxyl group, and, when there are two or more groups Y, the groups Y may be the same or different.

When using a polycyclic alicyclic compound other than the above preferable polycyclic alicyclic compounds, the following problems may occur depending on the molecular weight of the polycyclic alicyclic compound. Specifically, when using a polycyclic alicyclic compound having a high molecular weight as compared with the above preferable polycyclic alicyclic compounds, the film formation rate (i.e., a period of time required to obtain a thin film having a desired thickness) significantly decreases when producing a thin film by plasma polymerization according to the invention, whereby a thin film may not be efficiently produced. On the other hand, when using a polycyclic alicyclic compound having a low molecular weight as compared with the above preferable polycyclic alicyclic compounds, the resulting thin film may not be suitable as a semiconductor insulating interlayer due to an increase in dielectric constant.

A commercially available product or a product synthesized using a known method may be used as the above-mentioned polycyclic alicyclic compound. For example, the polycyclic alicyclic compound having a bromo group may be synthesized using a method disclosed in Macromolecules, 24, 5266 to 5268 (1991); J. Org. Chem., 45, 5405 to 5408 (1980); J. Polymer Sci., Part A: Polym. Chem., 30, 1747 to 1754 (1992); Ukr. Khim. Zh., 54, 437 and 438 (1988); or Chem. Ber., 93, 1366 to 1371 (1960). Furthermore, a derivative thereof may be synthesized by converting the bromo group using a common method.

The polycyclic alicyclic compound having a carboxyl group may be synthesized from the above-mentioned polycyclic alicyclic compound having a bromo group using a known synthesis method or a method disclosed in Tetrahedron Lett., 36, 1233 to 1236 (1995).

It is preferable to purify the thin film raw material according to the invention by washing, a treatment with an ion-exchange resin, reprecipitation, recrystallization, microfiltration, drying, or the like. A decrease in dielectric constant and an increase in strength and heat resistance of the resulting thin film can be achieved by thus removing ionic impurities (e.g., Fe³⁺, Cl⁻, Na⁺, and Ca²⁺), etc.

The thin film according to the invention is obtained by subjecting the above-mentioned polycyclic alicyclic compound to a film formation process. Plasma polymerization can be given as an example of the deposition (film formation) method.

The term “plasma polymerization” used herein refers to a method which causes the chemical reaction to proceed utilizing a plasma generated in a plasma polymerization film formation device due to power supplied from a high-frequency power supply. This deposition method obtains a thin film by causing a raw material (i.e., precursor) which produces a desired thin film to undergo a chemical reaction, and is classified as chemical vapor deposition (CVD).

In the invention, an arbitrary plasma polymerization film formation device (e.g., parallel-plate plasma polymerization device, dual-frequency-excitation parallel-plate plasma polymerization device, high-density plasma device, inductively-coupled plasma polymerization device, capacitively-coupled plasma polymerization device, or inductively-coupled plasma polymerization device) may be used insofar as the object of the invention is not impaired. A specific example using an inductively-coupled plasma polymerization device utilized in the examples of the invention and comparative examples is described below.

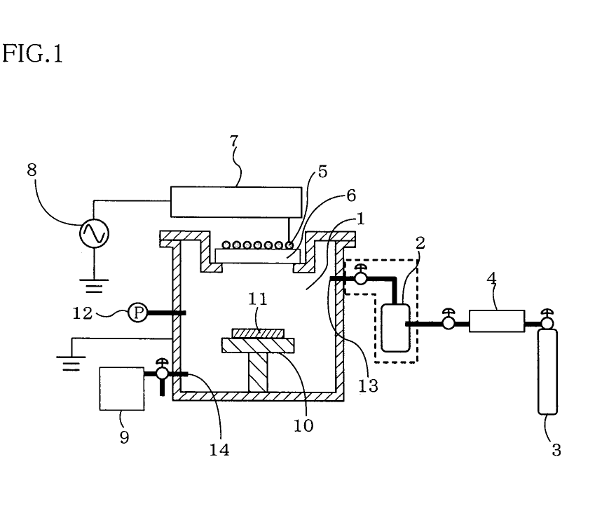

FIG. 1 is a schematic view showing an inductively-coupled plasma polymerization device.

The inductively-coupled plasma polymerization device has a configuration in which a chamber 1 (processing chamber) is connected with a vacuum pump 9 and an outlet 14 which evacuate the chamber 1, an inlet 13 through which a plasma source gas and a precursor substance are introduced, and a dielectric plate 6 which generates a plasma.

A thin film raw material tank 2, a plasma source gas tank 3, and a mass flow controller 4 which adjusts the flow rates of the thin film raw material and the plasma source gas are connected to the inlet 13.

The dielectric plate 6 is formed of quartz. An induction coil 5, a matching box 7, and a high-frequency power supply 8 are connected to the back side of the dielectric plate 6.

A variable temperature substrate stage 10 on which a processing target substrate 11 is placed is provided in the chamber 1. A pressure gauge 12 which measures the pressure inside the chamber 1 is also provided in the chamber 1.

As the raw material provided in the thin film raw material tank 2, the above-mentioned polycyclic alicyclic compounds may be used either individually or in combination of two or more. A compound other than the above-mentioned polycyclic alicyclic compound may also be used as an additive with the above-mentioned polycyclic alicyclic compound as the main component insofar as the object of the invention is not impaired.

Specifically, a polycyclic alicyclic compound commonly used for plasma polymerization, such as an adamantane derivative or a diamantane derivative having one or more hydroxyl groups or ethynyl groups (e.g., 1,3-adamantanediol, 1,3,5-trihydroxyadamantane, 1,3-diethynyladamantane, or 4,9-diethynyldiamantane), a compound (e.g., organic ammonium salt or styrene polymer) which produces holes in the thin film, or the like may be added.

The thin film raw material may be a bulk solid, a powder, a melt, a solution or a suspension using an organic solvent or water as a solvent, or a gas insofar as the thin film raw material can be introduced into the thin film raw material tank 2 of the plasma polymerization device and thin film production by plasma polymerization according to the invention is not adversely affected. The thin film raw material may be a combination of two or more of the above-mentioned forms. A known additive may be added insofar as the above-mentioned compound is used.

When using a thin film raw material in the form of a solution or a suspension, an organic solvent used as the solvent is not particularly limited. A common organic solvent may be arbitrarily used depending on the application.

Specific examples of the organic solvent include methanol, ethanol, isopropanol, acetone, dichloromethane, 1, 1,2,2-tetrachloroethane, trichloroethylene, ethyl lactate, propylene glycol methyl ether acetate, cyclohexanone, 2-methoxyethanol, N,N-dimethylformamide, toluene, xylene, and the like.

As the plasma source gas provided in the plasma source gas tank 3, an arbitrary substance may be used insofar as such a substance serves as the plasma source for plasma polymerization and the resulting thin film is not adversely affected. Specifically, an inert gas such as helium, argon, neon, krypton, or xenon is preferably used from the viewpoint of plasma generation efficiency and prevention of introduction of impurities into the film.

Formation of a thin film using the plasma polymerization device is described below.

The thin film raw material is airtightly provided in the thin film raw material tank 2. The substrate 11 on which a thin film is to be formed is placed on the stage 10. After closing all valves, the vacuum pump 9 is operated. The valve of the outlet 14 is opened so that the chamber 1 is evacuated. It is preferable to continuously evacuate by the pump 9 for a specific period of time after the pressure inside the chamber 1 has become equal to or smaller than a specific value (e.g., 5×10⁻³ Torr) in order to remove ionic impurities, compounds having an alkenyl group, a hydroxyl group, or an ether group, and the like which adhere to the chamber 1 and the substrate 11, which may adversely affect the thin film according to the invention.

The thin film raw material tank 2 and a pipe (i.e., portion enclosed by a dotted line in FIG. 1) from the thin film raw material tank 2 to the chamber 1 are heated using a ribbon heater or the like so that the thin film raw material tank 2 and the pipe are set at a temperature at which a vapor of the thin film raw material is produced at a sufficient partial pressure. The temperatures of the thin film raw material tank 2 and the pipe may be appropriately adjusted depending on the type of the raw material used and the desired performance and thickness of the resulting thin film. In the invention, the temperatures of the thin film raw material tank 2 and the pipe are preferably 0° C. to 450° C.

The substrate 11 is heated to a desired temperature utilizing the stage 10. The temperature of the substrate 11 may be appropriately adjusted depending on the reactivity of the thin film raw material with respect to a plasma or heat, the desired performance of the resulting thin film, and the like. In the invention, since the thin film raw material is the polycyclic alicyclic compound and the resulting thin film is a polymer of an organic substance, the temperature of the substrate 11 is preferably 0° C. to 450° C. from the viewpoint of the thermal stability of the thin film and prevention of adhesion of moisture to the substrate.

After confirming that the substrate 11 and the like have reached a desired temperature, the valve of the plasma source gas tank 3 and the valve of the inlet 13 are opened, and a mixture of the plasma source gas and a vapor of the thin film raw material is introduced into the chamber 1 while adjusting the flow rate using the mass flow controller 4. The valve of the outlet 14 and the valve of the inlet 13 are adjusted while checking the pressure gauge 12 so that the chamber 1 is set at a desired partial pressure (i.e., the partial pressure of the mixture of the plasma source gas and the vapor of the thin film raw material). After confirming that the system has become stable (e.g., the partial pressure inside the chamber 1 has been stabilized), a voltage at a desired frequency is applied to the induction coil 5 using the high-frequency power supply 8 while finely adjusting the voltage using the matching box 7 so that a plasma is generated in the chamber 1 due to the effect of the dielectric plate 6, whereby a thin film is formed by plasma polymerization. After generating a plasma for a specific period of time, the entire operation is stopped. A desired thin film is thus formed on the substrate 11.

As the substrate, an arbitrary sheet material may be suitably used insofar as the sheet material can be used as a known substrate. Specific examples of the substrate include a plastic sheet formed of polyethylene terephthalate, polycarbonate, polyacrylate, or the like, a glass sheet, a metal sheet, a silicon wafer, an inorganic oxide wafer, and the like. The size of the substrate may be appropriately adjusted within a range suitable for the size of the chamber and the variable temperature substrate stage.

The flow rate of the plasma source gas may be appropriately adjusted depending on the size of the device, the type of the substrate used, and the desired performance and thickness of the resulting thin film. The flow rate of the plasma source gas is preferably 10 ml/min to 500 ml/min.

The partial pressure of the mixture of the plasma source gas and the vapor of the thin film raw material vapor in the chamber 1 may be selected in the range from atmospheric pressure to 1×10⁻⁵ Torr depending on the desired performance and thickness of the resulting thin film. The partial pressure of the mixture is preferably 0.5 Torr to 1×10⁻³ Torr from the viewpoint of introduction of impurities into the thin film, and efficient plasma generation and film formation.

The frequency and power of the high-frequency power supply may be appropriately set depending on the type of the plasma source gas, the type of the thin film raw material, and the desired properties of the resulting thin film insofar as a plasma can be generated in the plasma polymerization device. For example, the frequency of the high-frequency power supply is typically 13.56 MHz, 27.12 MHz, 40.68 MHz, or the like. The power of the high-frequency power supply is selected in the range of 10 W to 500 W, and preferably 50 W to 200 W. When the power of the high-frequency power supply is lower than 10 W, a sufficient film formation rate may not be achieved. When the power of the high-frequency power supply is higher than 500 W, damage to the substrate, formation of an undesired thin film due to a decomposition reaction of the thin film raw material, a decrease in thickness due to an etching phenomenon of the thin film caused by plasma at an excessive energy intensity, or the like may occur.

According to the method of producing a thin film according to the invention, a thin film having a thickness of 10 nm to 10 μm can be produced. The thickness of the thin film may be determined by optical thickness measurement using an ellipsometer, a reflective optical film thickness meter, or the like, or by mechanical thickness measurement using a probe thickness meter, an AFM, or the like.

The thin film according to the invention is useful as a semiconductor insulating interlayer, an optical film used for a liquid crystal display, a liquid crystal projector, a plasma display, an EL display, an LED display, a CMOS image sensor, a CCD image sensor, or the like, or a material having high strength and high heat resistance due to low dielectric properties, high strength, high heat resistance, high transparency, and the like. The thin film according to the invention may be utilized in a semiconductor device, an image display device, an electronic circuit device, or a surface protective film including such a film or material.

The thin film according to the invention enables provision of an insulating interlayer into which holes need not be introduced. This may significantly improve the performance of a semiconductor device such as an ultra-large scale integrated (ULSI) circuit.

When using the thin film according to the invention as an insulating interlayer material for a ULSI multilayer wiring structure of a semiconductor device, since the properties such as a dielectric constant, heat resistance, strength, adhesion to a substrate, and stability vary depending on a value desired for a portion formed using the material, specific property values cannot be defined unconditionally. It is generally desirable that a dielectric constant be low and heat resistance, strength, adhesion to a substrate, and stability be high. The thin film formed of the polycyclic alicyclic compound according to the invention has these properties. Since the thin film according to the invention need not be polymerized (thermally cured) at a high temperature, the thin film according to the invention has high performance and is economical as compared with a known insulating interlayer material. Therefore, the thin film according to the invention may be suitably used as an insulating interlayer material.

The dielectric constant of the thin film according to the invention varies depending on the type of the raw material used, the type of the substituent, the position of the substituent, and the number of substituents. The dielectric constant k of the thin film according to the invention is preferably 3.6 or less, and more preferably 2.2 or less. The dielectric constant k of the thin film according to the invention may be appropriately adjusted within the above range by adjusting the type of the raw material used, the type of the substituent, the position of the substituent, and the number of substituents.

The lower limit of the dielectric constant k is one by definition. It is preferable that a semiconductor insulating interlayer have a dielectric constant k close to one. The dielectric constant k of the thin film according to the invention can be made close to one by adjusting the type of the raw material used, the type of the substituent, the position of the substituent, and the number of substituents. The dielectric constant k of the thin film according to the invention is about 1.5 in practice.

The dielectric constant of the thin film according to the invention may be determined using a known method in which the thin film having a known thickness is placed between electrodes having a known area, and the capacitance between the electrodes is measured.

Since the thin film obtained from the polycyclic alicyclic compound according to the invention is an amorphous polymer which mainly contains an adamantane skeleton and has a rigid three-dimensional mesh structure, the thin film has a low polarization rate and a low density over the entire thin film, and has a low dipole moment. Therefore, the thin film has a low dielectric constant. It is preferable that an insulating interlayer material for a ULSI multilayer wiring structure of a semiconductor device have a low dielectric constant because a delay of the signal transmission rate through a minute wire decreases.

The heat resistance of the thin film according to the invention is evaluated by treating the thin film in a high-vacuum heating furnace set at 400° C. and 3×10⁻³ Pa for five hours, and then measuring a thickness decrease rate by measuring the thickness of the thin film using a reflective film thickness meter. The thickness decrease rate of the thin film according to the invention is preferably 50 nm/h or less, and more preferably 30 nm/h or less. The heat resistance of the thin film according to the invention may also be determined by general thermophysical property evaluation using a differential scanning calorimeter (DSC), a thermogravimetry/differential thermal analysis (TG/DTA) device, or the like.

Since the thin film obtained from the polycyclic alicyclic compound according to the invention is an amorphous polymer which mainly contains an adamantane skeleton, the thin film has a three-dimensional structure corresponding to a diamond crystal lattice (Chemical Review, 277, 64, 1964). The thin film shows a very small amount of strain, and is thermally and chemically stable.

The strength of the thin film according to the invention varies depending on the structure of the polycyclic alicyclic compound according to the invention and the plasma polymerization film formation conditions. The thin film according to the invention has sufficient strength for an insulating interlayer material for a ULSI multilayer wiring structure of a semiconductor device.

The modulus of elasticity of the thin film according to the invention is preferably 5 to 100 GPa, and the hardness of the thin film according to the invention is preferably 0.5 to 10 GPa. A preferable modulus of elasticity of the thin film varies depending on the type and the structure of a semiconductor device or an electronic circuit device for which the thin film is used, a portion for which the thin film is used, the thickness of the thin film, and the like. The above range is preferable from the viewpoint of prevention of breakage of a multilayer structure formed using the thin film during production, the durability of the multilayer structure, and the like. The modulus of elasticity of the thin film as the standard of the strength of a low-dielectric material means a value evaluated using a nanoindentation method.

Since the thin film obtained from the polycyclic alicyclic compound according to the invention is an amorphous polymer which mainly contains an adamantane skeleton and has a rigid three-dimensional mesh structure as mentioned above, the thin film shows a small amount of inter-molecular creep, a low degree of chemical bond cleavage, and a small change in the steric structure of each molecule by applied stress so that it exhibits high strength.

The thin film according to the invention has excellent adhesion to a substrate such as a silicon substrate as compared with a known material. Adhesion to a substrate may be evaluated by a tape test (i.e., a tape is attached to a cross-cut thin film, and the adhesion of the thin film is evaluated by the number of cross-cut thin films which have been peeled off).

### EXAMPLES

Examples according to the invention are described in detail below. Note that the invention is not limited to the following examples. In the examples, a commercially-available thin film raw material or a thin film raw material prepared using a known method was used.

### Example 1

A thin film was formed on a silicon substrate using the plasma polymerization device shown in FIG. 1.

10 g of adamantane (thin film raw material) (manufactured by Aldrich Chemical) was placed in the thin film raw material tank 2. The substrate 11 was placed on the variable temperature substrate stage 10. After closing all valves, the vacuum pump 9 was operated. The valve of an outlet 14 was opened so that the chamber 1 was evacuated. The pressure inside the chamber 1 reached 1×10⁻³ Torr, and was maintained at 1×10⁻³ Torr or less. In order to remove impurities (e.g., moisture) adhering to the chamber 1 and the substrate 11, the pressure inside the chamber 1 was maintained at 1×10⁻³ Torr or less for 30 minutes.

The pipe from the thin film raw material tank 2 to the inlet 13 and the thin film raw material tank 2 (portion enclosed by a dotted line in FIG. 1) were heated to 150° C. using a ribbon heater. The substrate 11 (room temperature) was not heated. After a desired temperature had been reached, the valve of the plasma source gas tank 3 and the valve of the inlet 13 were opened, and a mixture of an argon gas (plasma source) and a vapor of the thin film raw material was introduced into the chamber 1 while adjusting the flow rate to 100 cc/min using the mass flow controller 4. The valve of the outlet 14 was adjusted so that the pressure inside the chamber 1 became 0.1 Torr while checking the pressure gauge 12.

After confirming that the system had become stable (e.g., the partial pressure inside the chamber 1 had stabilized), a voltage (frequency: 13.56 MHz, power: 100 W) was applied to the induction coil 5 using the high-frequency power supply 8 while finely adjusting the voltage using the matching box 7 so that a plasma was generated in the chamber 1 due to the effect of the dielectric plate 6, and plasma polymerization film formation was carried out for 10 minutes.

The device was then stopped. It was confirmed that a thin film was formed on the substrate 11 in the chamber 1.

The thickness of the resulting thin film was measured using a reflective film thickness meter. Specimens obtained by dividing the substrate into plural parts were evaluated as follows.

An aluminum electrode was deposited on the thin film side of the specimen, and the dielectric constant k was measured by performing a C-V measurement.

The heat resistance of another specimen was evaluated by treating the specimen in a high-vacuum heating furnace set at 400° C. and 3×10⁻³ Pa for five hours, and then determining the thickness decrease rate by measuring the thickness of the specimen using a reflective film thickness meter.

An adhesive tape peeling test was carried out. The strength (hardness and modulus of elasticity) of the thin film was measured by a nanoindentation method. The results are shown in Table 1.

TABLE 1

| | Example 1 | Example 2 | Example 3 | Example 4 | Example 5 | Comparative example 1 |
|---|---|---|---|---|---|---|
| Thin film raw material 1 | Adamantane | 1,3-Dibromo- | 1,3-Dibromo- | 1,3-Dibromo- | 1,3-Dibromo- | 1,3,5-Trihydroxy- |
| | | adamantane | adamantane | adamantane | adamantane | adamantane |
| Thin film raw material 2 | — | — | — | — | 1,3-Adamantane- | — |
| | | | | | diol | |
| Mixed gas partial pressure | 0.1 | 0.1 | 0.008 | 0.1 | 0.1 | 0.1 |
| (Torr) | | | | | | |
| High-frequency power (W) | 100 | 100 | 100 | 50 | 100 | 100 |
| Film thickness (nm) | 279 | 316 | 215 | 101 | 576 | 85 |
| Dielectric constant | 2.2 | 3.6 | — | 3.3 | — | 2.45 |
| Thickness decrease rate | 50 | 21 | 3 | 8 | 21 | 65 |
| (nm/h) | | | | | | |
| Peeling test* | Fair | Fair | Good | Fair | Fair | Bad |
| Hardness (GPa) | 0.61 | 0.70 | — | — | 0.68 | 0.43 |
| Modulus of elasticity (GPa) | 7.7 | 9.7 | — | — | 8.2 | 5.2 |

### Example 2

A thin film was formed in the same manner as in Example 1 except for using 1,3-dibromoadamantane as the thin film raw material instead of adamantane. The results are shown in Table 1.

### Example 3

A thin film was formed in the same manner as in Example 2 except for setting the partial pressure of the mixture of argon gas and a vapor of the thin film raw material at 0.008 Torr. The results are shown in Table 1.

### Example 4

A thin film was formed in the same manner as in Example 2 except for applying a power of 50 W to the induction coil using the high-frequency power supply. The results are shown in Table 1.

### Example 5

A thin film was formed in the same manner as in Example 1 except for using a mixture of 5 g of 1,3-dibromoadamantane and 5 g of 1,3-adamantanediol as the thin film raw material instead of 10 g of adamantane. The results are shown in Table 1.

### Comparative Example 1

A thin film was formed in the same manner as in Example 1 except for using trihydroxyadamantane as the thin film raw material instead of adamantane. The results are shown in Table 1.

The thin film obtained in Comparative Example 1 exhibited poor results as compared with the thin films obtained in Examples 1 to 5 except for a dielectric constant. In particular, the thin film obtained in Comparative Example 1 showed a very poor peeling test result and was considered as impracticable.

The thin film according to the invention is useful as a low-dielectric material, a high-strength material, a heat-resistant material, and the like in the electrical and electronic fields. Specifically, the thin film according to the invention may be used for semiconductor devices such as a CPU, a DRAM, and a flash memory, information processing small electronic circuit devices such as a thin film transistor produced by forming a pattern on the thin film and drawing a circuit, electronic circuit devices such as high-frequency communication electronic circuit devices, image display devices, surface protective films, optical films, and the like.

Although only some exemplary embodiments and/or examples of this invention have been described in detail above, those skilled in the art will readily appreciated that many modifications are possible in the exemplary embodiments and/or examples without materially departing from the novel teachings and advantages of this invention. Accordingly, all such modifications are intended to be included within the scope of this invention.

What is claimed is:

1. A thin film formed from at least one polycyclic alicyclic compound selected from among compounds of the following formulas (1), (2) and (3) as a precursor: 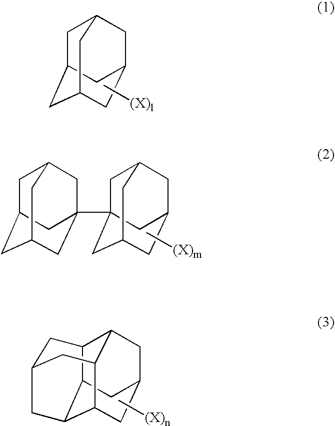
wherein X is a halogen group, a carboxyl group, a silyl group, a siloxy group, a nitro group, an amino group, an epoxy group, a fluorine-containing aliphatic group, a fluorine-containing aromatic group, a methyl group, an ethyl group, a substituted or unsubstituted saturated linear aliphatic group having 3 to 20 carbon atoms, a substituted or unsubstituted saturated branched aliphatic group having 3 to 20 carbon atoms, a substituted or unsubstituted saturated alicyclic substituent having 3 to 50 carbon atoms, or a substituted or unsubstituted aromatic group having 6 to 30 carbon atoms;
l, m, and n represent the number of substituents X, provided that 1 is an integer from 0 to 10, m is an integer from 0 to 18, and n is an integer from 0 to 14; and
when l, m, or n is two or more, the substituents X may be the same or different, and may be bonded to a single carbon atom or to different carbon atoms.

2. The thin film according to claim 1, wherein the polycyclic alicyclic compound is at least one polycyclic alicyclic compound selected from among adamantane, biadamantane, diamantane, and compounds of the following formulas (4) to (15): 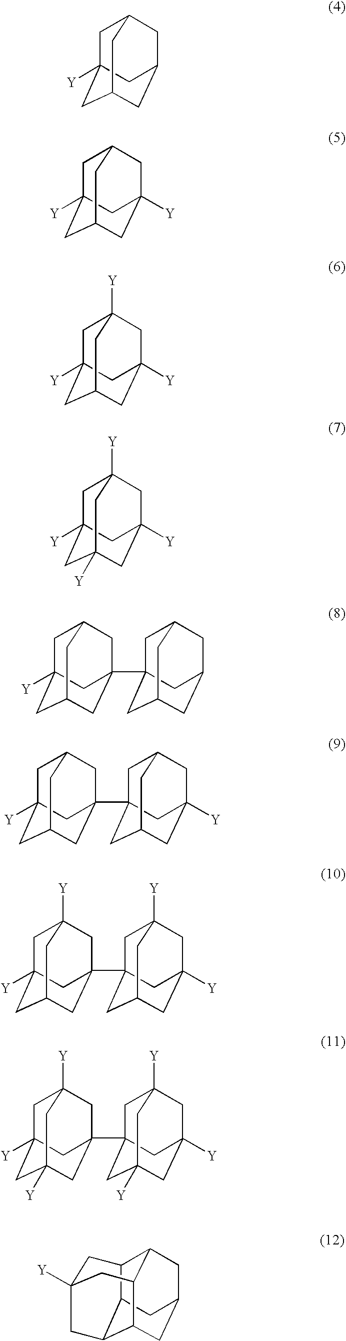 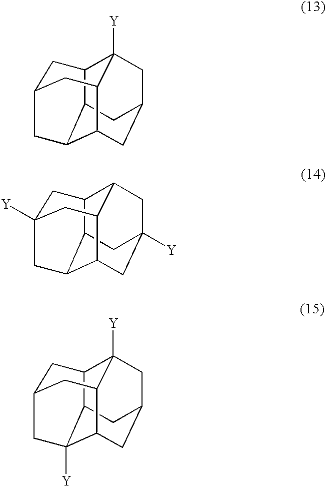
wherein Y is a bromo group or a carboxyl group, and, when there are two or more groups Y, the groups Y may be the same or different.

3. A method of producing the thin film according to claim 1 which is formed by plasma polymerization from the polycyclic alicyclic compound.

4. A method of producing the thin film according to claim 2 which is formed by plasma polymerization from the polycyclic alicyclic compound.

5. A low-dielectric material comprising the thin film according to claim 1.

6. A low-dielectric material comprising the thin film according to claim 2.

7. An insulating interlayer for a semiconductor comprising the thin film according to claim 1.

8. An insulating interlayer for a semiconductor comprising the thin film according to claim 2.

9. An optical film comprising the thin film according to claim 1.

10. An optical film comprising the thin film according to claim 2.

11. A high-strength, high-heat-resistant material comprising the thin film according to claim 1.

12. A high-strength high-heat-resistant material comprising the thin film according to claim 2.

13. A semiconductor device comprising the thin film according to claim 1.

14. A semiconductor device comprising the thin film according to claim 2.

15. An image display comprising the thin film according to claim 1.

16. An image display comprising the thin film according to claim 2.

17. An electronic circuit device comprising the thin film according to claim 1.

18. An electronic circuit device comprising the thin film according to claim 2.

19. A surface protective film comprising the thin film according to claim 1.

20. A surface protective film comprising the thin film according to claim 2.
